(19) United States
(12) Patent Application Publication
(10) Pub. No.: US 2005/0060533 A1
(43) Pub. Date: Mar. 17, 2005

(54) Method, device, software and apparatus for adjusting a system parameter value, such as a page closing time

(76) Inventors: Steven Woo, Saratoga, CA (US); Bradley May, San Jose, CA (US); Rong Fang, Sunnyvale, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/664,762

(22) Filed: Sep. 17, 2003

(51) Int. Cl. G06F 1/24

(52) U.S. Cl. 713/100

(57) ABSTRACT

Embodiments of the present invention allow a method, device, software and apparatus to adjust a system parameter, such as a page closing time value, in order to enhance a processing device performance. For example, a method includes initializing a page closing time value by a BIOS software component. A processing device, such as a computer, operates responsive to the page closing time value. For example, the computer executes a graphic display software program. An operational value, such as a difference between page hits and page misses, is obtained while executing the software program and compared to a threshold value. The page closing time value is then adjusted responsive to the comparison. In an alternate embodiment of the present invention, an adaptive circuit is included in a memory controller and includes a first counter capable to obtain a number of page hits and a second counter capable to obtain a number of page misses. Comparator logic is coupled to the first and second counters and outputs a page closing time adjust signal.

### FIELD OF THE INVENTION

The present invention relates to adjusting system parameters in a processing device.

### BACKGROUND OF INVENTION

Processing devices, such as a computer, typically include multiple hardware components, such as a processor, memory controller, memory module, disk drive, graphics card or other hardware components. Before the computer executes application software programs, a Basic Input/Output Software (“BIOS”) software program is usually used to set or initialize system parameters used in a hardware component operation. A system parameter may be stored in a hardware component and may represent a time value. For example, a system parameter may include a time value representing how long a disk drive is inactive before entering a power saving or sleep mode.

Typically, a system parameter is not altered once a BIOS software program initializes a system parameter value and application programs are executing. However, there may be certain modes of operations of a computer, particular application programs or particular hardware component configurations in which altering a system parameter value may enhance performance.

Therefore, it is desirable to provide a method, device, software and apparatus that adjusts a system parameter value during the operation of a processing device in order to improve processing device performance.

### SUMMARY OF INVENTION

Embodiments of the present invention allow a method, device, software and apparatus to adjust a system parameter, such as a page closing time value, in order to enhance processing device performance.

According to an embodiment of the present invention, a method includes initializing a system parameter value, such as a page closing time value, by a BIOS software component. A processing device, such as a computer, operates responsive to the system parameter value. An operational value, such as a difference between page hits and page misses, is obtained and compared to a threshold value. The system parameter value is then adjusted responsive to the comparison.

According to an embodiment of the present invention, an adaptive circuit is included in a memory controller and includes a first counter capable to obtain a number of page hits and a second counter capable to obtain a number of page misses. Comparator logic is coupled to the first and second counters and outputs a parameter adjust signal responsive to comparing the difference and the threshold value.

According to another embodiment of the present invention, a system parameter value is a processor operating frequency or the number of memory devices in a memory module.

According to another embodiment of the present invention, a method comprises the steps of counting a number of page hits and a number of page misses during a period of time. The number of page hits and page misses are compared. A page closing time value is then adjusted in response to the comparing step.

According to an embodiment of the present invention, the page closing time value is increased, decreased or remains unchanged responsive to the comparing step.

According to an embodiment of the present invention, a device includes a first counter capable to output a number of page misses during a period of time and a second counter capable to output a number of page hits during the period of time. Comparator logic is coupled to the first and second counters, and outputs an adjust signal responsive to a comparison of a difference between the number of page hits and the number of page misses to one or more threshold values. According to an embodiment of the present invention, the device is a memory controller and the adjust signal adjusts a page closing time value stored in the memory controller coupled to a memory module.

According to an embodiment of the present invention, a BIOS software component initializes the period of time and the threshold value.

According to an embodiment of the present invention, an apparatus comprises a master device coupled to a memory device capable to provide data. The master device is capable of retrieving the data responsive to a page closing time value. The master device includes a first counter capable to output a number of page misses during a period of time and a second counter capable to output a number of page hits during the period of time. A comparator logic is coupled to the first and second counters and is capable of outputting an adjust signal to adjust the page close time value.

In an embodiment of the present invention, the comparator logic outputs the adjust signal responsive to a difference between the number of page misses and page hits and a threshold value.

In an embodiment of the present invention, the master device is a memory controller, graphics card or processor.

In an embodiment of the present invention, the memory is a Dynamic Random Access Memory (“DRAM”) device.

In an embodiment of the present invention, the memory is included in a memory module.

In an embodiment of the present invention, an article of manufacture including a processor readable medium, stores a BIOS software component capable to initialize a system parameter, a first software component capable of obtaining an operational value and a second software component capable of adjusting the system parameter responsive to the operational value.

According to an embodiment of the present invention, a device includes a memory capable of storing a page closing time value and means for adjusting the page closing time value responsive to an operational value.

These embodiments of the present invention, as well as other aspects and advantages, are described in more detail in conjunction with the figures, the detailed description, and the claims that follow.

### BRIEF DESCRIPTION OF THE DRAWINGS

FIG. 1 is a block diagram illustrating an apparatus in accordance with an embodiment of the present invention.

FIG. 2. is circuit diagram of adaptive circuit 111 shown in FIG. 1 in accordance with embodiments of the present invention.

FIG. 3 is a block diagram of a memory 106 in accordance with an embodiment of the present invention.

FIG. 4 is a flow chart of a method 400 in accordance with an embodiment of the present invention.

FIG. 5 is a histogram of the number of page hits as a function of the time since the page was last accessed for all reads in accordance with an embodiment of the present invention.

FIG. 6 is a histogram of the number of page misses as a function of the time since a page was last accessed for all reads in accordance with an embodiment of the present invention.

FIG. 7 illustrates a cumulative distribution function corresponding to a probability density function in accordance with an embodiment of the present invention.

FIG. 8 illustrates a cumulative distribution function corresponding to a probability density function in accordance with an embodiment of the present invention.

FIG. 9 illustrates a cumulative distribution function in accordance with an embodiment of the present invention.

FIGS. 10a-b illustrate when a memory page should be closed for a first application software component in accordance with an embodiment of the present invention.

FIGS. 11a-b illustrate when a memory page should be closed for a second application software component in accordance with an embodiment of the present invention.

### DETAILED DESCRIPTION

Embodiments of the present invention allow a method, device, software and apparatus to adjust a system parameter, such as a page closing time value, in order to enhance a processing device performance. For example, a method includes initializing a page closing time value by a BIOS software component. A processing device, such as a computer, operates responsive to the page closing time value. For example, the computer executes a graphic display software program. An operational value, such as a difference between page hits and page misses, is obtained while executing the software program and compared to a threshold value. The page closing time value is then adjusted responsive to the comparison. In an alternate embodiment of the present invention, an adaptive circuit is included in a memory controller and includes a first counter capable to obtain a number of page hits and a second counter capable to obtain a number of page misses. Comparator logic is coupled to the first and second counters and outputs a page closing time adjust signal for changing a page closing time value.

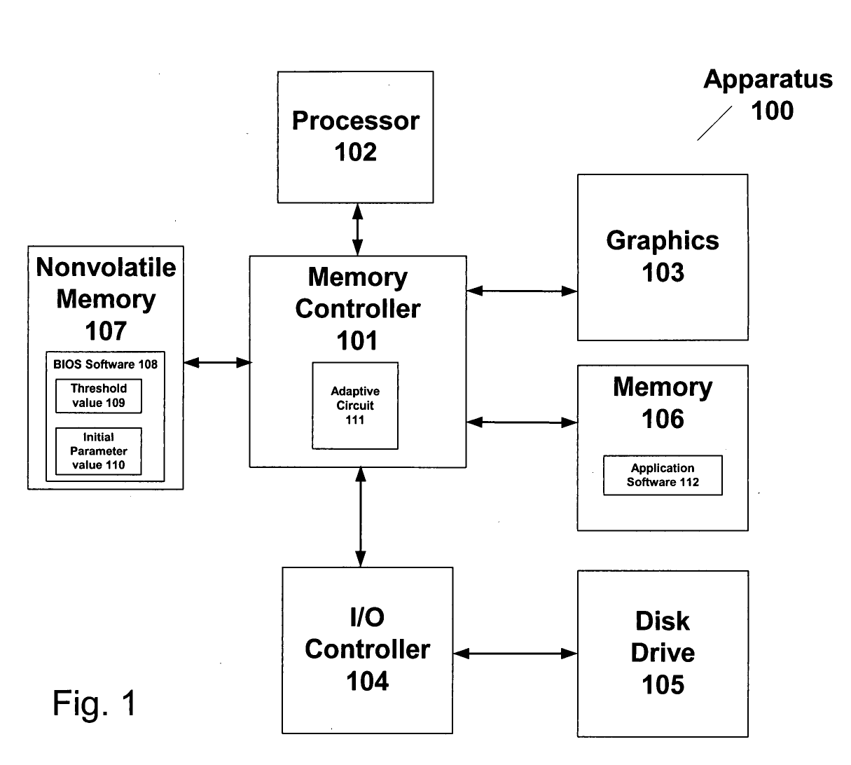

FIG. 1 illustrates a block diagram of an apparatus 100, such as a processing device or computer, having a plurality of circuit components according to an embodiment of the present invention. In an alternate embodiment of the present invention, apparatus 100 is a game console or portable computer. One of ordinary skill in the art would appreciate that alternate embodiments of the present invention include more or less circuit components and may be alternatively coupled. A circuit component, such as a processor 102, illustrated in FIG. 1 represents a semiconductor device, subassembly, or card, singly or in combination thereof, in various embodiments of the present invention. In an embodiment of the present invention, the block diagram of FIG. 1 is applicable to intrachip, as well as interchip, communications. Circuit components are coupled by conducting elements as represented by the arrows shown in FIG. 1. In an embodiment of the present invention, a conducting element includes a metal wire, trace or cable, singly or in combination. In various embodiments of the present invention, a single conducting element, or multiple conducting elements such as a bus, is used to communicate between circuit components. Control and/or data information is transferred between circuit components in various embodiments of the present invention.

Apparatus 100 includes a processor 102, such as a central processor unit coupled to a memory controller 101. In an embodiment of the present invention, a master device, such as memory controller 101, includes an adaptive circuit 111 capable of adjusting a system parameter value, such as a page closing time value, during operation of apparatus 100. In alternate embodiments of the present invention, adaptive circuit 111 is included in other circuit components. In an alternate embodiment of the present invention, a system parameter value is adjusted by a software component stored in memory controller 101. For example, memory controller 101 includes an article of manufacture having processor readable software components. A first software component obtains an operational value while apparatus 100 is operating and a second software component adjusts a system parameter value responsive to the operational value. In alternate embodiments of the present invention, the processor readable software components are stored and executed in other circuit components of apparatus 100. In embodiments of the present invention, software components referenced herein represent a software program, software object, software function, software subroutine, software method, software instance, and code fragment, singly or in combination.

Memory controller 101 is also coupled to a graphics circuit component 103, such as a graphics card and a memory 106. A memory system includes memory controller 101and memory 106 in an embodiment of the present invention.

In an embodiment of the present invention, memory 106 includes a plurality of memory devices having respective storage arrays or includes one or more memory modules. In an embodiment of the present invention, memory 106 includes one or more DRAM devices. In an alternate embodiment of the present invention, memory 106 includes different types of DRAM. In still a further embodiment of the present invention, memory 106 includes other types of writeable and readable memory technologies.

In an embodiment of the present invention, an application software component 112, such as a graphics software program, is stored in memory 106. Memory controller 101 is also coupled to I/O controller 104 that is coupled to disk drive 105.

Memory controller 101 is also coupled to nonvolatile memory 107, such as Electrically Erasable Programmable Read-Only (“EEPROM”) memory. In an embodiment of the present invention, a BIOS software component 108 is stored in nonvolatile memory 107 and is used to initialize apparatus 100. In particular, BIOS software component 108 uses stored values, such as an initial parameter value 110 and threshold value 109, to initialize values in memory controller 101 and other circuit components. In an embodiment of the present invention, other values are used by BIOS software component 108 to initialize apparatus 100. In still a further embodiment of the present invention, system parameters are initialized by hardware and not BIOS software component 108. In still a further embodiment of the present invention, all or a portion of BIOS software component 108 is stored in memory 106.

In alternate embodiments of the present invention, system parameters include, but are not limited to, a number of master devices, a processor 102 operating frequency, an organization of memory 106, such as a number of memory devices, a number of ranks of memory devices, a number of banks, a size of pages in each bank, a width of a memory bus, a width of the memory device, a type of memory device, an operating frequency of the memory devices, a number of open pages tracked by memory controller 101, an address mapping scheme, a currently executing application software component, where in time the currently executing application software component is executing (i.e. during the beginning or end of the application software component), a number of currently executing software components, a number of memory modules in power saving mode, or other system parameters that are initialized before the operation of apparatus 100 and are adjusted during operation in order to improve performance.

Apparatus 100 performance improvements, according to embodiments of the present invention, include reduced power consumption and reduced Average Memory Access Time (“AMAT”) in embodiments of the present invention.

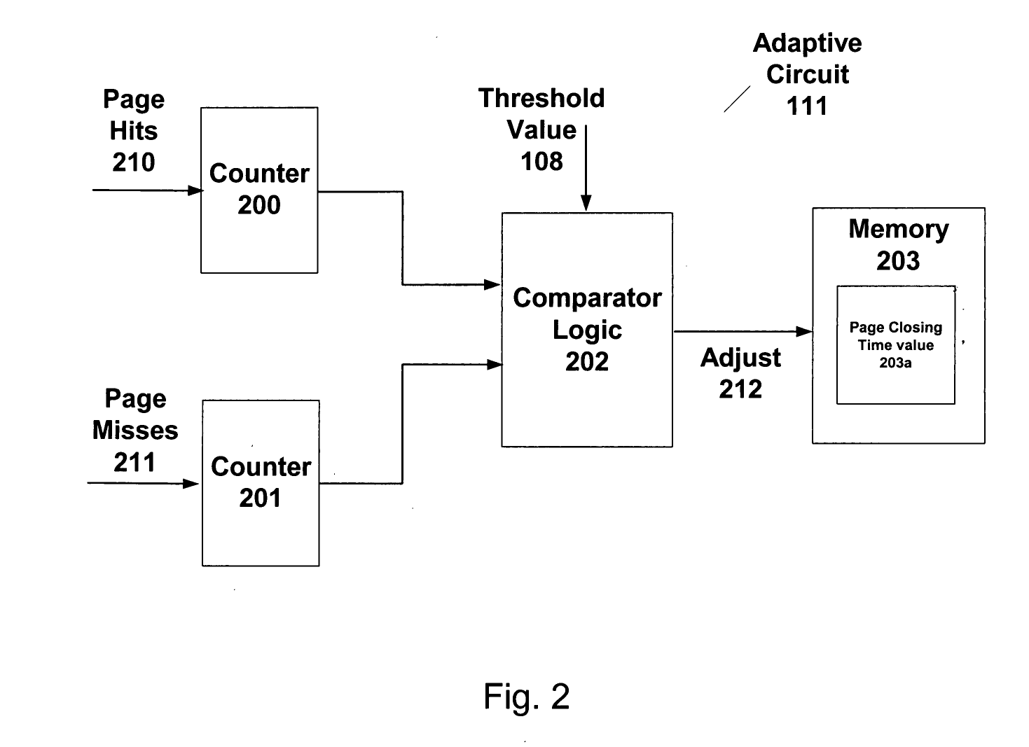

FIG. 2 illustrates an adaptive circuit 111 in memory controller 101 shown in FIG. 1according to an embodiment of the present invention. Adaptive circuit 111 includes counter 200 for counting and outputting a number of page hits responsive to a Page Hit signal 210 during a period of time. Likewise, counter 201 counts and outputs a number of page misses responsive to a Page Miss signal 211 during the same period of time. In an embodiment of the present invention, BIOS software component 108 initializes the period of time. Comparator logic then outputs an Adjust signal 212 responsive to a comparison of the inputted number of page hits and page misses as described in detail below. Adjust signal 212 includes incrementing, decrementing or not changing a page closing time value 203a stored in memory 203 of memory controller 101 in an embodiment of the present invention. A page closing time value 203a determines the length of time a memory page is kept open. In an embodiment of the present invention, a difference between the number of page hits and page misses is compared to a Threshold value 109 provided by BIOS software component 108. In an alternate embodiment of the present invention, a Threshold value 109 is not used. In sum, adaptive circuit 111 using operational values, such as the number of page hits and misses during a predetermined period of time, to adjust a system parameter value, such as a page closing time value during operation of apparatus 100.

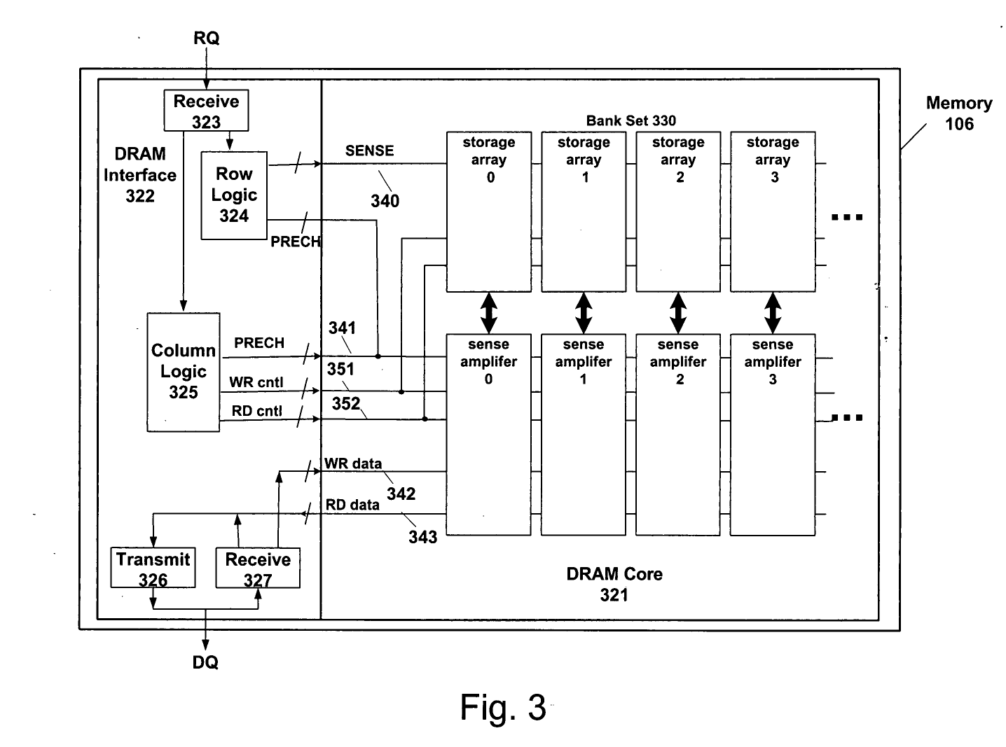

Memory 106 is a memory device having a plurality of storage arrays and sense amplifiers as seen in FIG. 3 in an embodiment of the present invention. In an alternate embodiment of the present invention, memory 106 is a memory module having a plurality of memory device semiconductors having respective storage arrays connected by a memory module bus. In an embodiment of the present invention, memory controller 101 communicates with memory 106 by a bidirectional memory bus having control lines RQ and data signal lines DQ as shown in FIG. 3.

FIG. 3 illustrates a memory 106 according to an embodiment of the present invention. Memory 106 includes DRAM core 321 and DRAM interface 322. DRAM core 321 includes a bank set 330 having storage arrays 0-N and respective sense amplifiers 0-N in an embodiment of the present invention. DRAM interface 322 is coupled to lines RQ and DQ, which represent a bus in an embodiment of the present invention. In particular, receive logic 323 is coupled to lines RQ to receive a command signal. Likewise, transmit logic 326 and receive logic 327 are coupled to lines DQ to transmit and receive data on lines DQ. Receive logic 323 is coupled to row logic 324 and column logic 325. In an embodiment of the present invention, request or command signals are generated on lines RQ from memory controller 101. These command signals cause control signals to be generated from row logic 324 and column logic 325, on lines 340, 341, 351 and 352 to storage arrays 0-N and sense amplifiers 0-N. For example, row logic 324 may generate a sense (“SENSE”) command on lines 340 to storage array 0 while column logic 325 may generate a precharge (“PRECH”) command on line 341 to sense amplifier 1. Column logic 325 also can generate write and read control signals (“VVR cntrl” and “RD cntrl”) on lines 351 and 352 to sense amplifiers 0-N, respectively. Data is written (“WR data”), by way of line 342, or read (“RD data”), by way of line 343, to or from sense amplifiers 0-N and transmitted or received on lines DQ responsive to command signals received on lines RQ.

Sense amplifiers 0-N buffer data read from storage arrays 0-N for long periods of time. Sense amplifiers 0-N act as a data cache within DRAM core 321 offering lower access latency if the data being retrieved already resides in a sense amplifier, known as a page hit.

However, if data in a sense amplifier is from a different row of the corresponding storage array, the sense amplifier is precharged, a proper row of a corresponding storage array is then sensed and then the data is retrieved from the sense amplifier, known as a page miss.

Alternatively, sense amplifiers 0-N are precharged in advance of requests or commands to memory 106 so that memory requests are generally required to sense the proper row and then return data from sense amplifiers 0-N, known as a page closed access. These three access types of memory operations have different latencies associated with them that follow the below relationship:
page hit latency<page closed latency<page miss latency (1)

A memory controller 101 that keeps data in a sense amplifier after the data access is completed uses an open page policy or logic, whereas a memory controller that precharges sense amplifiers after data access uses a closed page policy or logic.

While embodiments of the present invention include adjusting a page closing time value in a memory controller 101, other memory controllers that have different types of policies or logic may also include a parameter value that is initialized and then adjusted responsive to measured and/or calculated operational values. For example, a memory controller 101 may include a policy or logic that buffers data in the last several sense amplifiers accessed (for example, four), known as an open page policy that allows four open pages in an embodiment of the present invention. In this embodiment of the present invention, a system parameter value is the number of allowed open pages. In still a further embodiment of the present invention, a memory controller 101 may include a policy or logic that buffers data in predetermined sense amplifiers for a predetermined period of time. In this embodiment of the present invention, an adjustable system parameter is the predetermined period of time. In yet another embodiment, a memory controller 101 is used which results in the lowest Average Memory Access Latency or Time (“AMAT”) for a particular workload, or application software component being executed. In yet another embodiment, a memory controller 101 may be used which results in the highest performance for a particular workload. In yet another embodiment, a memory controller 101 is used which results in the lowest power consumption and/or lowest power dissipation for a particular workload, to ensure that circuit components do not exceed predetermined operating temperatures.

If an apparatus 100 does not include a system parameter that is not adaptable or changeable during operation, optimal performance of apparatus 100 will most likely not be achieved. For example, after memory controller 101 is initialized, memory controller 101 includes a policy or logic, which requires pages to be precharged if they have not been accessed during the last 8 memory bus cycles. In this example, a system parameter value is initialized to 8 memory bus cycles. However, memory system characteristics may be such that this initialized system parameter is not optimal. In fact, during the course of a single application software component 112 execution, it is likely that different system parameter values will be optimal at different points in time. Some application software components 112 have good address locality at the beginning of execution as linear data structures are initialized. In this situation, a parameter value and memory controller 101 that keep pages open as long as possible can be very effective in minimizing memory 106 access latency. However, in later portions of executing application software component 112, after processor 102 caches have been filled with data, memory requests may become more random. In this situation, a system parameter value and memory controller 101 that close pages if they are not accessed after a short period of time (i.e. 8 cycles, for example) may achieve the best performance, or minimize memory 106 access latency.

Thus, adaptive circuit 111 or an adaptive software component in embodiments of the present invention improves performance of apparatus 100, and in particular performance of memory controller 101 and memory 106. In general, using a memory controller 101 with an initialized system parameter for the entire duration of an execution of application software component 1 12, whose locality of memory requests varies with time, will not achieve the performance of memory controller 101 having a system parameter than can be adapted responsive to measured and/or calculated operational values. Furthermore, as apparatus 100 executes other application software components, these application software components may have different memory locality characteristics. A memory controller 101 having a fixed system parameter value, for example page closing time, is unlikely to be optimal across a broad range of application software components, as compared to a memory controller 101 that can tailor itself to the needs of the particular executing application software component.

While the below description describes in detail how a system parameter value, such as a page closing time, is adapted, other system parameter values that affect power consumption/power dissipation or data transfer rates may likewise be adapted. Ensuring lower power consumption means lower dissipation, so that circuit components will not heat up as much, and which may allow devices to operate within their specified limits. Also, lower power consumption enables increased battery lifetimes for laptops and portable processing devices. Another aspect of reducing power consumption and/or power dissipation includes adjusting a system parameter value affecting the number of devices in different power states and/or switch between page policies (i.e. from an open page policy to a closed page policy or from a closed page policy to an open page policy to change how much power is consumed/dissipated by the memory system). Changing memory system power consumption will have an effect on memory system performance, and hence overall apparatus 100 performance, which can also reduce the power consumption of other circuit components in apparatus 100, such as processor 102. Reducing power consumption/dissipation by reducing overall apparatus 100 performance is an acceptable tradeoff in many laptop and portable embodiments of the present invention.

It is desirable from a performance standpoint to keep pages open so long as this increases overall performance. One metric that is often a key indicator of system performance is memory latency. Because memory latency varies depending on whether or not pages are being kept open, and because it varies with the page hit rate of an application software component, it is appropriate to use AMAT as a performance metric to be optimized by the memory system. In order to improve AMAT in apparatus 100, it is desirable to keep pages open as long as this results in reduced memory latency, otherwise, higher performance might be obtained if the pages are closed. The AMAT for a memory system that implements closed pages is simply:
AMAT_{closed}=Page closed latency. (2)
While the AMAT for a memory system that keeps all pages open is:
AMATₒₚₑₙ=fₕᵢₜ*Page hit latency+(1−fₕᵢₜ)*Page miss latency (3)
where fₕᵢₜ is the fraction of data requests of memory 106 that result in page hits, and (1−fₕᵢₜ) is the fraction of data requests of memory 106 that result in page misses. For a memory controller 101 that minimizes memory latency, pages should be kept open so long as
AMAT_{closed}≧AMATₒₚₑₙ. (4)
Substituting equations (2) and (3) into (4) yields:
Page closed latency≧fₕᵢₜ*Page hit latency+(1−fₕᵢₜ)*Page miss latency. (5)

For a memory system where memory 106 is a conventional RDRAM® device, the representative latencies of page hits, page empties, and page misses are shown below:
Page closed latency=page hit latency+7 cycles
Page miss latency=page hit latency+15 cycles.
This can be re-written as:
Page hit latency=Page closed latency−7 cycles (6a)
Page miss latency=Page closed latency+8 cycles. (6b)
And approximated as:
Page hit latency˜Page closed latency−8 cycles (7a)
Page miss latency=Page closed latency+8 cycles. (7b)
Substituting (7a) and (7b) into equation (5) yields:
Page closed latency≧fₕᵢₜ*(Page closed latency−8 cycles)+(1−fₕᵢₜ)*(Page closed latency+8 cycles). (8)
Reducing (8) results in
Page closed latency≧Page closed latency−16*.fₕᵢₜ+8 (9)
0≧−16 fₕᵢₜ+8 (10)
fₕᵢₜ≧0.5 (11)
Thus, memory latency will be minimized for an open page policy as long as 50% or more of the data requests result in page hits. That is, for an embodiment of the present invention, as long as there are more page hits than page misses, memory latency will be minimized. Note that substituting equations (6a) and (6b) into equation (5) would yield a slightly different answer, but one which does not change the general methodology being used.

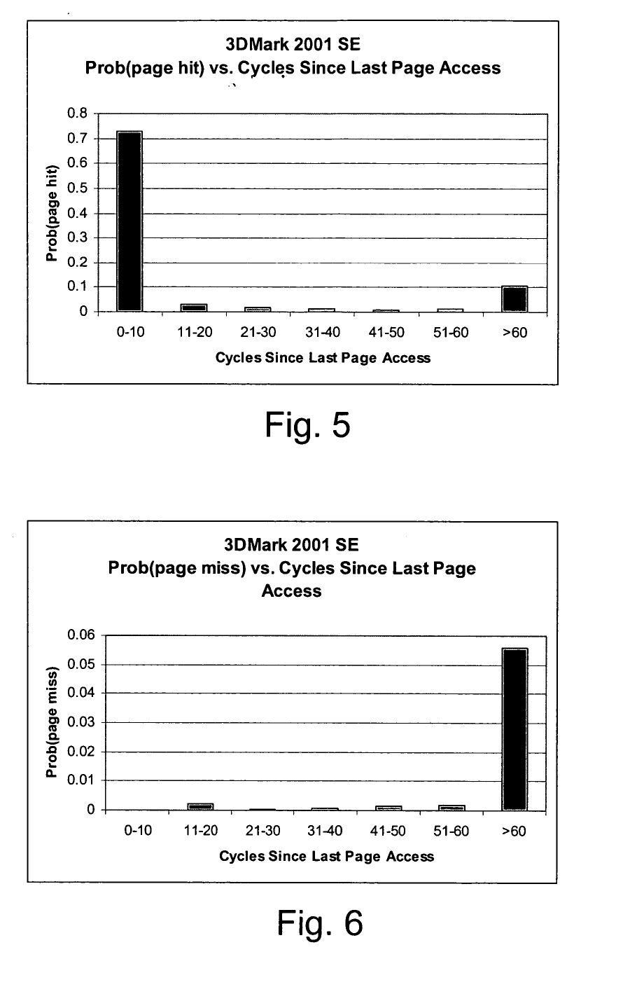

FIGS. 5-11 show the results of trace analysis to determine the optimal length of time to leave pages open when using different application software components. In a first embodiment of the present invention, a graphics application component is used. In particular, FIGS. 5-6 show histograms when using a 3DMark 2001SE application program. FIG. 5 shows a histogram of the number of page hits as a function of the time since the page was last accessed for all read accesses or requests. FIG. 6 shows a histogram of the number of page misses as a function of the time since a page was last accessed for all read accesses. In an embodiment of the present invention, write commands or access are not considered as write latency typically does not affect an application program performance as strongly as read latency. In an alternate embodiment, write accesses can be considered independently or in conjunction with read accesses.

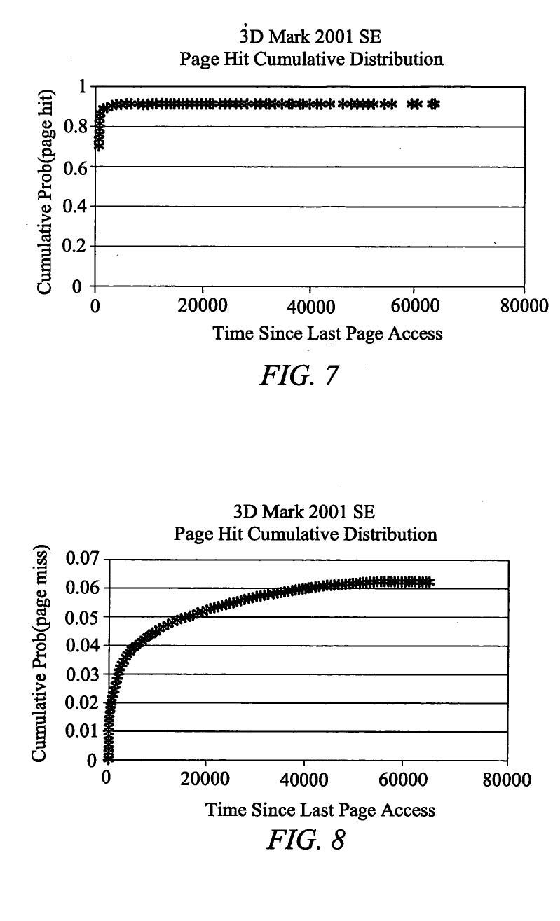

The histograms shown in FIGS. 5 and 6 show that page hits tend to occur soon after a page was last accessed, while page misses tend to occur a longer time after a page was accessed. These histograms can be thought of as probability density functions that reflect the probability that a data request will be a page hit/page miss as a function of the time since the last page access. The corresponding cumulative distribution functions for these probability density functions are shown in FIGS. 7 and 8.

These cumulative distribution functions are used to determine how long to keep pages open for a particular application software component. Referring back to Equation (11), an open page policy will achieve a lower AMAT than a closed page policy if at least 50% of the memory requests are page hits. If this is not the case, then pages should be closed. Stated in other words, pages should be kept open so long as the probability of a page hit exceeds the probability of a page miss. In an embodiment of the present invention, we can plot the probability of a page hit minus the probability of a page miss given the time since a page was last accessed. When this function is greater than zero, there is a higher probability of a page hit, so the page should be left open in order to keep AMAT below that of a closed page policy. When this function drops below zero, the probability of a page miss exceeds that of a page hit, so AMAT will exceed that of a closed page policy, meaning that pages should be closed:
F(x)=Prob(Page Hit−Page Miss|Time Since Last Page Access) (12)
Plotting F(x) and determining when F(x) transitions from being greater than 0 to less than 0 indicates the point in time that pages should be closed.

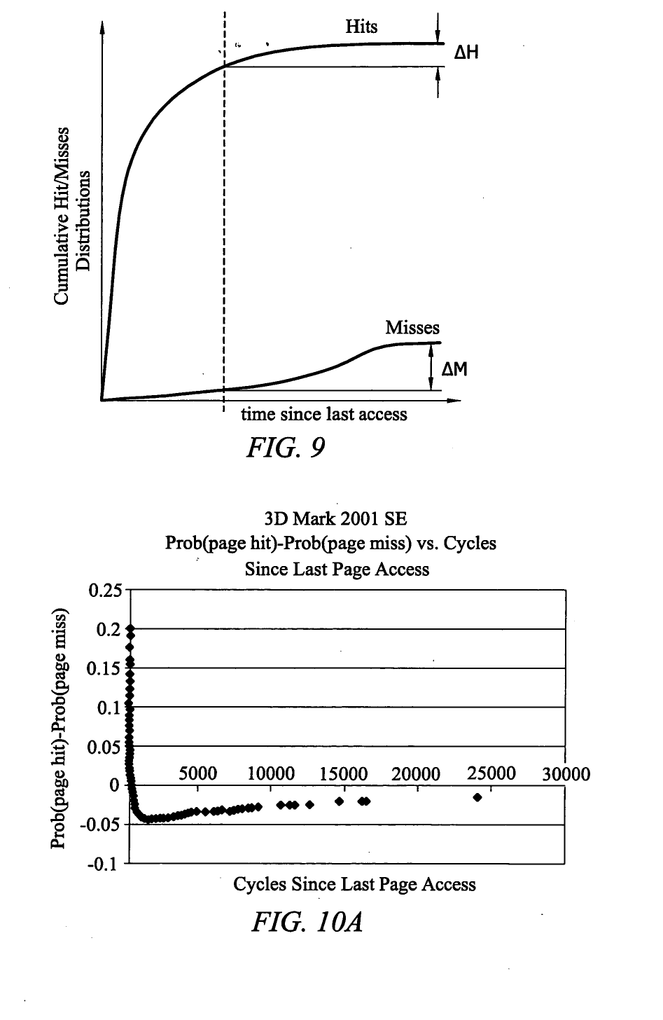

The cumulative distribution functions can be used in the following description and are shown in FIG. 9. At any time since the last access to an open page, the probability of a page hit is simply ΔH/(ΔH+ΔM), where ΔH is the difference between the Page Hit cumulative distribution function (“PHCDF”) at times ∞ and t, and ΔM is the difference between the Page Miss cumulative distribution function (“PMCDF”) at times ∞ and t. Similarly, the probability of a page miss is simply ΔM/(ΔH+ΔM).
Prob(Page Hit|Last Access t Time Ago)=ΔH/(ΔH+ΔM) (PHCDF(∞)−PHCDF(t)/(PHCDF(∞)−PHCDF(t)+PMCDF(∞)−PMCDF(t)) (13a)
Prob(Page Miss|Last Access t Time Ago)=ΔM/(ΔH+ΔM) (PHCDF(∞)−PHCDF(t)/(PHCDF(∞)−PHCDF(t)+PMCDF(∞)−PMCDF(t)) (13b)

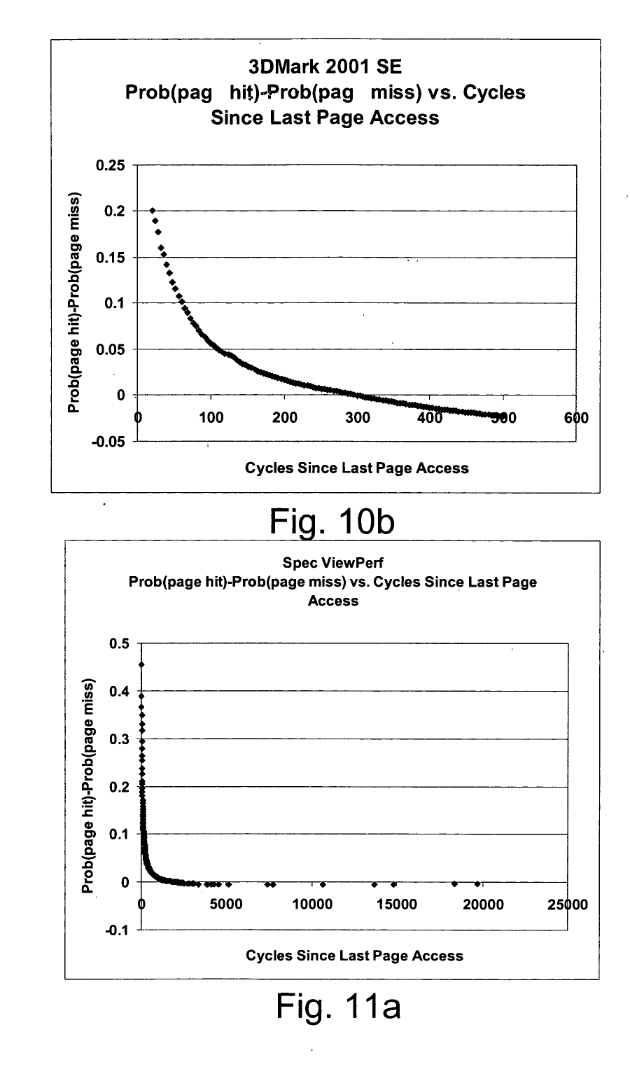

The cumulative distribution functions provide a new function F(x) shown in FIGS. 10a-b using Equation (12) and a 3DMark 2001 SE application software program. FIG. 10b illustrates a close-up view of a zero crossing of FIG. 10a. Equation (11) states that latency will be minimized if the page hits out number page misses. For FIGS. 10a-b, this will be true so long as Prob(page hit)-Prob(page miss)≧0. The X-axis crossing point determines the point at which pages should be closed for this application software component. For a 3DMark 2001 SE application software program, if an open page has not been accessed in 300 cycles, then the page should be closed.

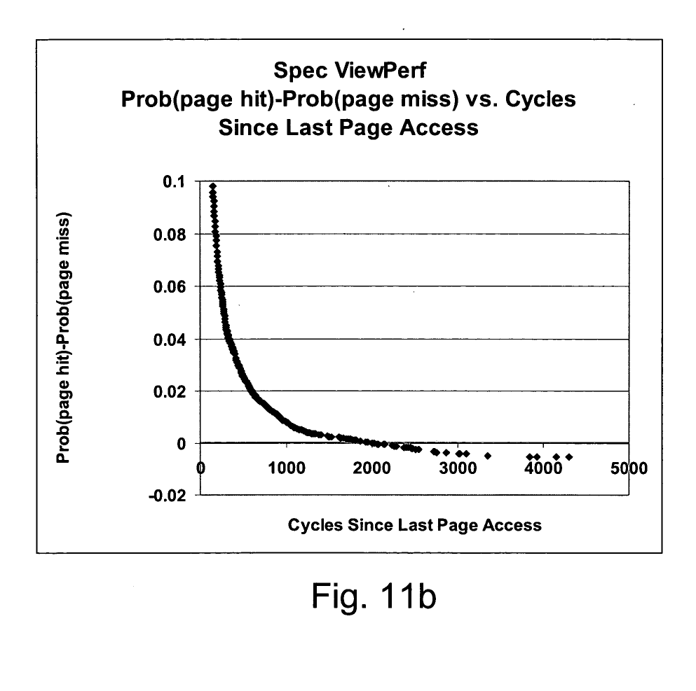

Different application software components will have different X-axis crossing points. In an alternate embodiment, a second application software component, such as a Spec ViewPerf application program, exhibits a different crossing point (at 1996 cycles) as shown in FIGS. 11a-b. FIG. 11b illustrates a close-up view of a zero crossing of FIG. 11a.

In an embodiment of the present invention, memory controller 101 includes a page closing time value 203a that is adjusted based on the execution of an application software component 112. For each page that is open, memory controller 101 tracks the amount of time since the page was last accessed in an embodiment of the present invention. Memory controller 101 tracks the time since a page was last accessed by any operation, or by a subset of all possible operations (e.g. only Read operations) in an embodiment of the present invention. In an alternate embodiment, instead of tracking the time since a page was last accessed, memory controller 101 tracks the time since the page was opened. For this embodiment, memory controller 101 tracks, on a per-bank basis, the time since the last Read operation to each open page. Data from 3DMark 2001 SE and Spec ViewPerf application software programs (as well as several other application programs) shows that, while a page closing time may work well for one application program, other application programs may benefit from dramatically different page closing time values. The optimal time to close pages can change within an application software program as computation moves from one state of operation (which has certain characteristics) to another state of operation (which has different characteristics). Furthermore, the optimal time to close pages may also change with the characteristics of other circuit components, such as the operating frequency of processor 102. Clearly, the ability to adapt a page closing time value 203a based on the characteristics of apparatus 100 can improve performance.

In the examples shown above, the hit and miss statistics across all pages in a memory system are considered together to come up with a single page closing time. In other embodiments, it may be desirable to track the page closing time on a per-page basis, a per-bank basis, a per-rank basis, or at some other unit of granularity.

As described above, an adaptive circuit 111 is used to adjust a page closing time value 203a using counters 200, 201 and comparator logic 202. In an alternate embodiment of the present invention, controller 101 uses a first measuring software component to count page misses and page hits for a period of time during an execution of an application software component 112 during a particular state of apparatus 100 operation. For example, a particular state of operation of apparatus 100 is when memory controller 101 can track only a predetermined number of open pages. An alternate state of apparatus 100 operation includes when only one memory device is included in memory 106. A first measuring software component then measures page hits and misses. Cumulative distribution functions are then derived by a second calculating software component to find an X-axis crossing. A third adaptive software component then alters a page closing time, corresponding to an X-axis crossing when the application software component 112 is being executed by processor 102 during the measured state of apparatus 100 operation.

In an alternate embodiment of the present invention, an adaptive software component measures and compares the number of page hits to page misses over a predetermined period of time. If the number of page hits is much smaller than the number of page misses, then the page closing time is reduced by the adaptive software component. If the number of page hits is much larger than the number of page misses, then the page closing time is increased by the adaptive software component. If the number of page hits is approximately equal to the number of page misses, then the page closing time can be kept the same. A new period of time over which to accumulate page hits and misses can be initiated by the adaptive software component.

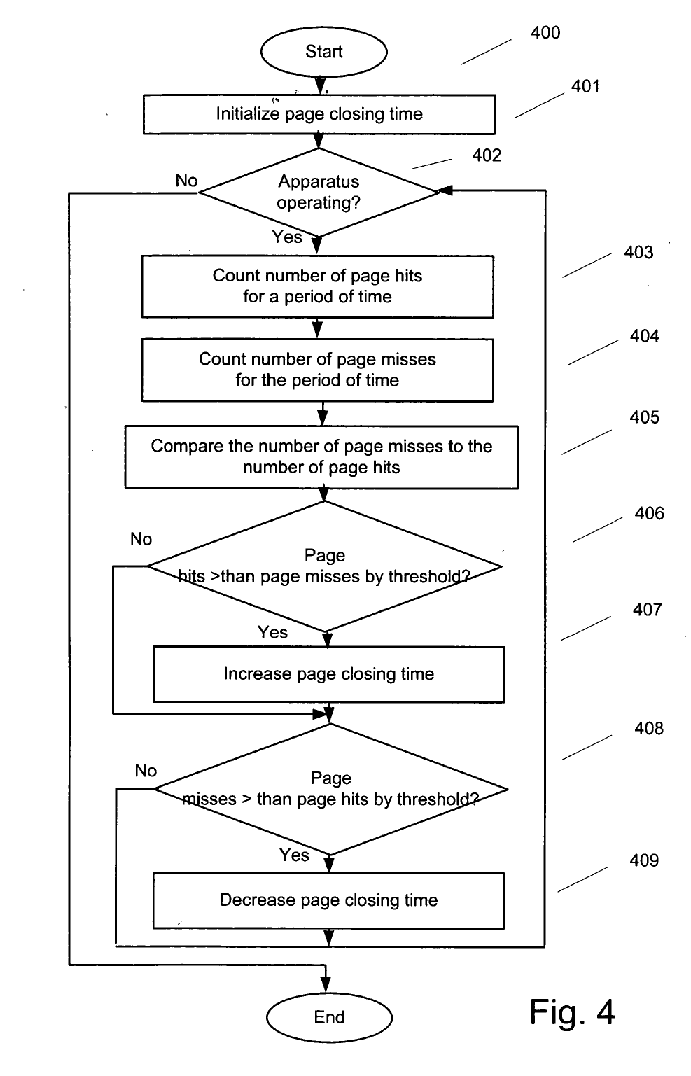

FIG. 4 illustrates a method 400 according to embodiments of the present invention. In alternate embodiments of the present invention, steps illustrated in FIG. 4 are carried out by hardware, software or a combination thereof. In alternate embodiments, the steps illustrated in FIG. 4 are carried out by the components illustrated in FIGS. 1 and 2. As one of ordinary skill in the art would appreciate, other steps that are not shown may be included in various embodiments of the present invention.

FIG. 4 illustrates a method 400 for adjusting a page closing time value according to an embodiment of the present invention. Method 400 begins by initiating a system parameter value, such as a page closing time value, as illustrated by logic block 401. In an embodiment of the present invention, a page closing time value is initiated by BIOS software component 108. In an alternate embodiment of the present invention, system parameter values are initiated by hardware. A determination is made whether an apparatus is operating in logic block 402. In an embodiment of the present invention, the determination is made in response to a power-up or power-down of apparatus 100. If Apparatus 100 is operating, control passes to logic block 403; otherwise, method 400 ends. A number of page hits for a period of time is counted as illustrated in logic block 403. In an embodiment of the present invention, this is accomplished by counter 200. In an alternate embodiment of the present invention, this is accomplished by a software component. Similarly, the number of page misses for a period of time is counted as illustrated in logic block 404. In an embodiment of the present invention, the number of page hits and page misses are counted during the same predetermined period of time. Because the benefit of a page hit shown in Equation (7a) is approximately equal to the penalty of a page miss shown in Equation (7b), the number of page hits can be compared directly to the number of page misses to determine if pages are being left open too long as shown in logic block 405. In an embodiment of the present invention, the comparing step is performed periodically, for example every refresh interval, over some other predetermined or dynamically determined length of time, or after a predetermined or dynamically determined number of events, such as after some number of memory accesses.

If the number of page hits exceeds the number of page misses (or if it exceeds the number of page misses by some threshold value), then the page closing time should be greater than or equal to its current value as shown in logic blocks 406 and 407. Likewise, if the number of page misses exceeds the number of page hits (or if it exceeds the number of page hits by some threshold value), the page closing time should be less than its current value as shown in logic blocks 408 and 409. If the number of page hits and page misses is roughly equal (or if they differ by an amount below some threshold value), then the page closing time can remain unchanged.

A page closing time value is adjusted by a fixed step size, or a difference between the number of page hits and page misses in embodiments of the present invention. For example, if the number of page hits greatly exceeds the number of page misses; the page closing time can be increased by an amount larger than would be the case if the two counter values were nearly equal. In an alternate embodiment of the present invention, a page closing time value is not adjusted until the difference between page hits and page misses are greater than a predetermined threshold value. In an alternate embodiment, the page closing time value can be halved or doubled from its current value responsive to a comparison.

Method 400 then passes control to logic block 402 and repeats as long as apparatus 100 is in an operational state.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1) A method, comprising the steps of:
initializing a system parameter;
operating a processing device responsive to the system parameter;
obtaining an operational value;
comparing the operational value to a threshold value; and,
adjusting the system parameter responsive to the comparing step.

2) The method of claim 1, wherein the system parameter is a page closing time stored in a memory controller.

3) The method of claim 2, wherein the obtaining step includes determining a difference between page hits and page misses during a period of time.

4) The method of claim 3, wherein the obtaining step is performed by a first counter capable to obtain a number of page hits and a second counter capable to obtain a number of page misses and comparator logic capable to output a parameter adjust signal responsive to the difference and the threshold value.

5) The method of claim 1, wherein the initializing step is performed by a BIOS software component.

6) The method of claim 1, wherein the system parameter is a processor operating frequency.

7) The method of claim 1, wherein the system parameter is the number of memory devices in a memory module operating in a particular mode of operation.

8) A method, comprising the steps of:
counting a number of page hits during a period of time;
counting a number of page misses during the period of time;
comparing the number of page hits to the number of page misses; and,
adjusting a page closing time value responsive to the comparing step.

9) The method of claim 8, wherein the adjusting step includes:
increasing the page closing time value responsive to the comparing step.

10) The method of claim 8, wherein the adjusting step includes:
decreasing the page closing time value responsive to the comparing step.

11) The method of claim 8, wherein the number of page hits is greater than the number of page misses.

12) The method of claim 8, wherein the number of page hits is less than the number of page misses.

13) A device, comprising:
a first counter capable to output a number of page misses during a period of time;
a second counter capable to output a number of page hits during the period of time; and,
a comparator logic, coupled to the first and second counters, capable to output an adjust signal responsive to a comparison of a difference between the number of page hits and page misses to a threshold value.

14) The device of claim 13, wherein the adjust signal increments a page closing time value.

15) The device of claim 13, wherein the adjust signal decrements a page closing time value.

16) The device of claim 13, wherein an average memory access time (“AMAT”) is decreased.

17) The device of claim 13, wherein power consumption is decreased.

18) The device of claim 13, wherein a BIOS software component initializes the period of time and the threshold value.

19) The device of claim 13, wherein the adjust signal adjusts a page closing time value stored in the memory controller.

20) The device of claim 13, wherein the device is a memory controller.

21) The device of claim 13, wherein the device is coupled to a memory module.

22) An apparatus, comprising:
a master device capable to retrieve data responsive to a page close time value, including,
a first counter capable to output a number of page misses during a period of time;
a second counter capable to output a number of page hits during the period of time;
a comparator logic, coupled to the first and second counters, capable to output an adjust signal responsive to a comparison of a difference between the number of page hits and page misses to a threshold value, wherein the adjust signal adjusts the page close time value; and,
a memory device, coupled to the master device, to provide the data.

23) The apparatus of claim 22, wherein the threshold value and the period of time is initialized by a BIOS software component.

24) The apparatus of claim 22, wherein the master device is a memory controller.

25) The apparatus of claim 22, wherein the master device is a processor.

26) The apparatus of claim 22, wherein the memory device is a Dynamic Random Access Memory (“DRAM”) device.

27) The apparatus of claim 22, wherein the memory device is included in a memory module.

28) An article of manufacture, including a processor readable medium, comprising:
a first software component capable to initialize a system parameter;
a second software component capable of obtaining an operational value; and,
a third software component capable of adjusting the system parameter responsive to the operational value.

29) A device, comprising:
a memory capable of storing a page closing time value; and,
means for adjusting the page closing time value responsive to an operational value.
